(19) United States
(12) Patent Application Publication
(10) Pub. No.: US 2008/0060202 A1
(43) Pub. Date: Mar. 13, 2008

(54) CUTTING BLADE ASSEMBLY OF ROTATION DRUM TYPE ELECTRIC RAZOR

(76) Inventor: Tae-Jun Oh, Gyeonggi-do (KR)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/748,813

(22) Filed: May 15, 2007

(30) Foreign Application Priority Data
Sep. 12, 2006 (KR) 20-2006-0024493

(51) Int. Cl. B26B 19/14

(52) U.S. Cl. 30/43.6

(57) ABSTRACT

The present invention relates to a cutting blade assembly of a rotation drum type electric razor, it includes a razor body on which an on/off switch is formed and in which a driving motor operated by the on/off switch is embedded, a driving support that is formed uprightly on the left and right side of the razor body faced each other and on the upper end of which a plurality of connection holes is formed, a power transmission means that is provided between the driving support and is connected to the driving motor to transmit a driving force, a cutting blade assembly that is shaft-connected to the connection hole of the driving support and to which a driving force is transmitted from the power transmission means to rotate at a high speed, and is provided with cutting blades, and a cover that is hook-connected to the upper surface of the razor body and on which a net covering the cutting blade assembly is formed.

### CROSS-REFERENCE TO RELATED APPLICATIONS

This application claims the right of priority based on Korean Patent Application No. 10-2006-0024493 entitled “A CUTTING BLADE ASSEMBLY OF ROTATION DRUM TYPE ELECTRIC RAZOR”, filed on Sep. 12, 2006, and incorporated herein by reference.

### FIELD OF THE INVENTION

The present invention relates to a cutting blade assembly of a rotation drum type electric razor, and more particularly to a cutting blade assembly of a rotation drum type electric razor in which a cutting angle is granted with a cutting blade of a drum type blade assembly in a motion of rotation within a safety net, and thus it can improve a cutting effect and solve a problem in that hairs are held between the cutting blades after shaving.

### BACKGROUND ART

Typically, a cutting blade assembly of a rotation type electric razor includes a main body, a motor housed on a central shaft inside the main body and a power transmission mechanism that transmits a rotation force from the motor to a driving shaft of an cutting blade assembly, wherein a razor cover provided with a safety net is covered over the cutting blade assembly.

Accordingly, the prior cutting blade assembly 1 is formed such that, as shown in FIG. 11, a plurality of lines of cutting blade 3 that is inclined spirally is formed on the whole outer circumferential surface of a cylindrical body 2 made of metal material, and a cutting action is performed in a space from a safety net covered over the cutting blade 3.

Here, a driving shaft 4 is inserted into a center of the cylindrical body 2 and driven gear-teeth are formed on both ends such that power is transmitted from a power transmission mechanism. In addition, the cutting blade 3 is formed integrally on a surface of the cylindrical body made of metal material, which is formed by an insert ejection way, and a separate metal SUS blade is inserted and installed on a outer circumferential surface of the cylindrical body 2 and performs a cutting action together with the cutting blade 3.

In the cutting blade assembly of a rotation drum type electric razor as configured in a aforementioned way, cutting blades are formed integrally on a outer circumferential surface of a cylindrical body formed by an insert ejection way and perform a cutting action together with a SUS blade, wherein there is no cutting angle thereof to decrease a cutting effect and further a length of a cutting blade is short such that hairs are held between the cutting blades after shaving.

### SUMMARY OF THE INVENTION

Accordingly, the present invention has been proposed to solve the above problems, and the object of the present invention is to provide a cutting blade assembly of rotation drum type electric razor in which a cutting angle is granted with a cutting blade of a drum type blade assembly to improve a cutting effect and for hairs not to be held between the cutting blades after shaving.

In addition, another object of the present invention is to provide a cutting blade assembly of rotation drum type electric razor in which an assembly and disassembly are performed easily and a connection thereof is secure to improve durability.

A cutting blade assembly of a rotation drum type electric razor according to the present invention includes a razor body 100 on which an on/off switch 110 is formed and in which a driving motor 120 operated by the on/off switch 110 is embedded, a driving support 200 that is formed uprightly on the left and right side of the razor body 100 faced each other and on the upper end of which a plurality of connection holes is formed, a power transmission means 300 that is provided between the driving support 200 and is connected to the driving motor 120 to transmit a driving force, a cutting blade assembly 400 that is shaft-connected to the connection hole of the driving support 200 and to which a driving force is transmitted from the power transmission means 300 to be rotated at a high speed, and is provided with cutting blades, and a cover 500 that is hook-connected to the upper surface of the razor body 100 and on which a net 510 covering the cutting blade assembly 400 is formed.

Here, the cutting blade assembly 400 includes a plurality of cutting blades 410, 412′ that is formed extending in a longitudinal direction, on an inner diameter side of which a plurality of first connection grooves 412, 412′ formed and on both ends of which second connection groove 414, 414′ are formed, a plurality of support pieces 420, 420′ in a form of a circular plate on which a plurality of cutting blade connection grooves 422, 422′ to be connected to a plurality of first connection grooves 412, 412′ of the cutting blade 410, 410′, is formed along the outer circumference, and on a center of which a hexagonal hole 424, 424′ is formed, a driving shaft 430 on both ends of which a circular shaft part 432 to one side of which the driving support 200 is connected and to the other side of which the power transmission means 300 is connected, is formed, and which includes a hexagonal shaft part 434 that is fitted into the hexagonal hole 424, 424′ provided at a center of the support piece 420, 420′ between the respective circular shaft part 432; and a fixing piece 440 on which a connection rib 442 to be connected to the second connection groove 414, 414′ of the cutting blade 410, 410′ is formed, and on which a through hole 444 through which the circular shaft part 432 of the driving shaft 430 is formed.

Meanwhile, the cutting blade 410 is connected to the cutting blade connection groove 422 to form a cutting angle θ1, which is formed to have a predetermined inclination angle θ with respect to the support piece 420 support piece, wherein the cutting blade is formed as a horizontal plate type that is connected to the cutting blade connection groove 422 corresponding to the same line downright the first connection groove 412 of the cutting blade 410.

In addition, the cutting blade 410′ is connected to the cutting blade connection groove 422′ to form a cutting angle θ3, which is formed to have a predetermined inclination angle θ2 with respect to the support piece 420, wherein the cutting blade is formed as a spiral plate type that is connected to in order the cutting blade connection groove 422′ of the support piece 420′ next to one cutting blade connection groove 422′ of the support piece 420′, corresponding to the same line downright the first connection groove 412′ of the cutting blade 410′, along the trace of spiral arc.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a perspective view showing schematically the whole cutting blade assembly of a rotation drum type electric razor according to the present invention;

FIG. 2 is a perspective view showing schematically the main part of a cutting blade assembly of a rotation drum type electric razor according to the present invention;

FIG. 3 is an exploded perspective view showing schematically a cutting blade of the cutting blade assembly of a rotation drum type electric razor according to the present invention;

FIG. 4 is a sectional view showing a cutting blade assembly on a horizontal plate of the cutting blade assembly of a rotation drum type electric razor according to the present invention;

FIG. 5 is a side view showing a cutting blade assembly on a horizontal plate of the cutting blade assembly of a rotation drum type electric razor according to the present invention;

FIG. 6 is a perspective view showing schematically the whole cutting blade assembly of a rotation drum type electric razor according to another embodiment of the present invention;

FIG. 7 is a perspective view showing schematically the main part of a cutting blade assembly of a rotation drum type electric razor according to another embodiment of the present invention;

FIG. 8 is an exploded perspective view showing schematically a spiral cutting blade assembly of a rotation drum type electric razor according to another embodiment of the present invention;

FIG. 9 is a sectional view showing a spiral cutting blade assembly according to another embodiment of the present invention;

FIG. 10 is a side view showing a spiral cutting blade according to another embodiment of the present invention; and

FIG. 11 is a view showing a cutting blade assembly of a rotation drum type electric razor according to the prior art.

### DETAILED DESCRIPTION

Hereinafter, a configuration of a cutting blade assembly of a rotation drum type electric razor according to the present invention will be described in detail, referring to the accompanied drawings.

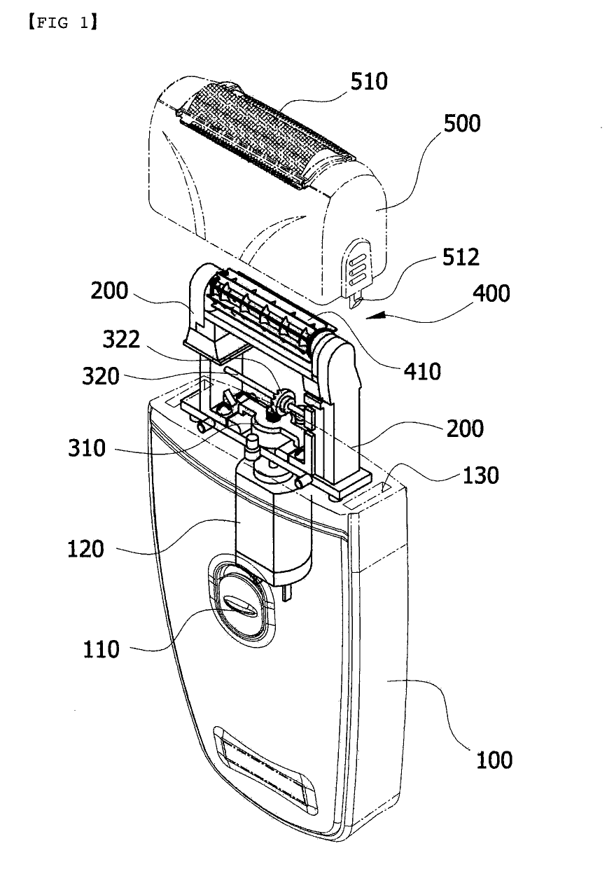

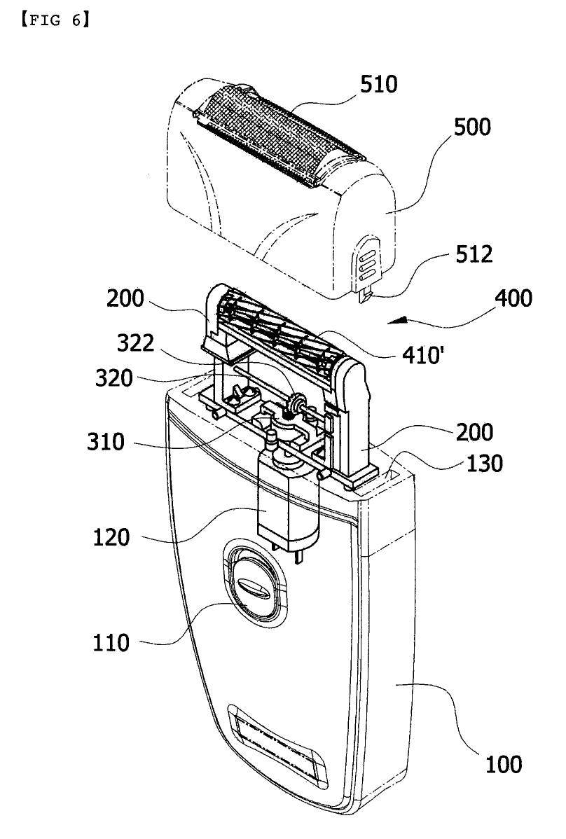

A cutting blade assembly of a rotation drum type electric razor according to the present invention, as shown in FIG. 1 or 6, includes a razor body 100 and a support 200, a power transmission means 300, a cutting blade assembly 400 and a cover 500. Here, a on/off switch 110 is formed on a front surface of the razor body 100 and a driving motor 120 that forms a driving shaft 122 and is operated by a application of power source by the on/off switch 110. In addition, a cover fastening hole 130 is formed in a form of slim for easy carrying and keeping on the upper surface of the razor body 100 such that the later cover 500 is fastened thereto.

A fastening hole (not shown) is formed on the upper end of the driving support 200, and the driving supports 200 are formed uprightly faced each other between the cover fastening holes 130 formed on the right and left upper sides of the razor body 100. Here, the later power transmission means 300 is provided on at least one side of the driving support 200.

The power transmission 300 includes a driving motor connection part 310, a power transmission rotation shaft 320 and power transmission gear part 330. Here, the driving motor connection part 310 is formed such that the motor shaft 122 of the driving motor 120 is connected to one side of the upper surface of the razor body 100, and a spur gear 312 being rotated together with a rotation of the motor shaft 122 is installed on upper side of the driving motor connection part 310.

The power transmission rotation shaft 320 is connected rotatably between the driving supports 200 formed uprightly faced each other on the upper surface of the razor body 100. In addition, one end of the power transmission rotation shaft 320 is connected to at least one gear of the later power transmission gear part 330, and a crown gear 322 that is geared to the spur gear 312 installed on the upper surface of the driving motor connection part 310, is formed on one side of the power transmission rotation shaft 320. Here, the crown gear 322 converts a horizontal rotation force from the spur gear 312 of the driving motor connection part 310 into a vertical rotation force to transmit a driving force to the power transmission rotation shaft 320.

The power transmission gear parts 330 are geared to one surface of at least one driving support 200 formed uprightly faced each other on upper surface of the razor body 100 by a plurality of gears, and shaft-installed. In more detail, the plurality of gears is formed preferably as spur gears, and includes a lower spur gear 332, a middle spur gear 334 and a upper spur gear 336. Here, one end of the aforementioned power transmission rotation shaft 320 is connected to the lower spur gear 332 installed on the lower side of the driving support 200 such that a vertical rotation force from the power transmission rotation shaft 320 is transferred to the plurality of geared-middle spur gear 334 and further to the upper spur gear 336. Accordingly, a rotation force of the upper spur gear 336 that is transmitted from the middle spur gear 334 drives the driving shaft 430, which is connected to the upper spur gear 336, of the later cutting blade assembly 400 that is connected to the upper connection hole (not shown) of the driving support 200, and thus rotates the cutting blade assembly 400.

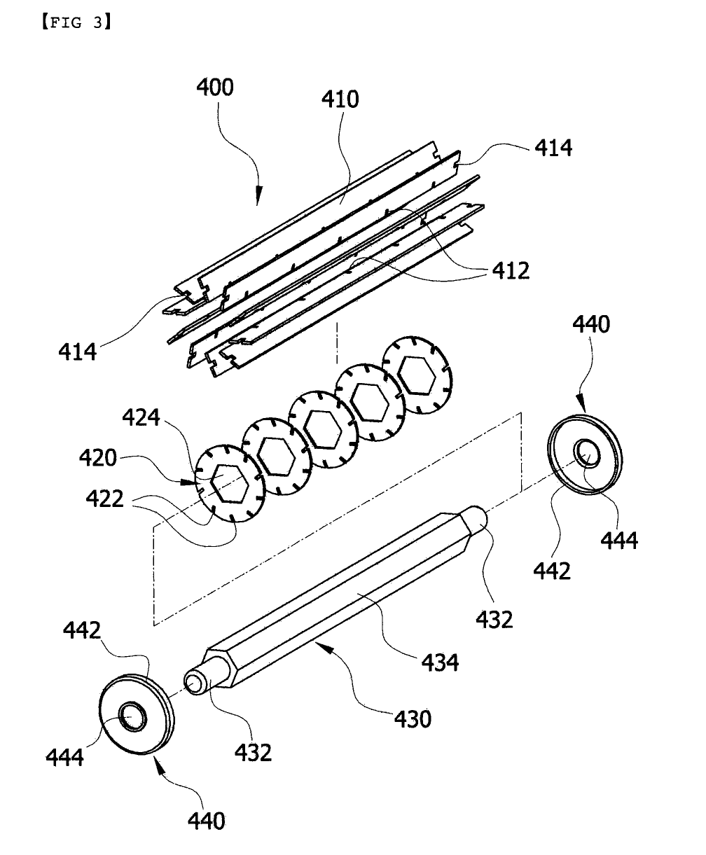

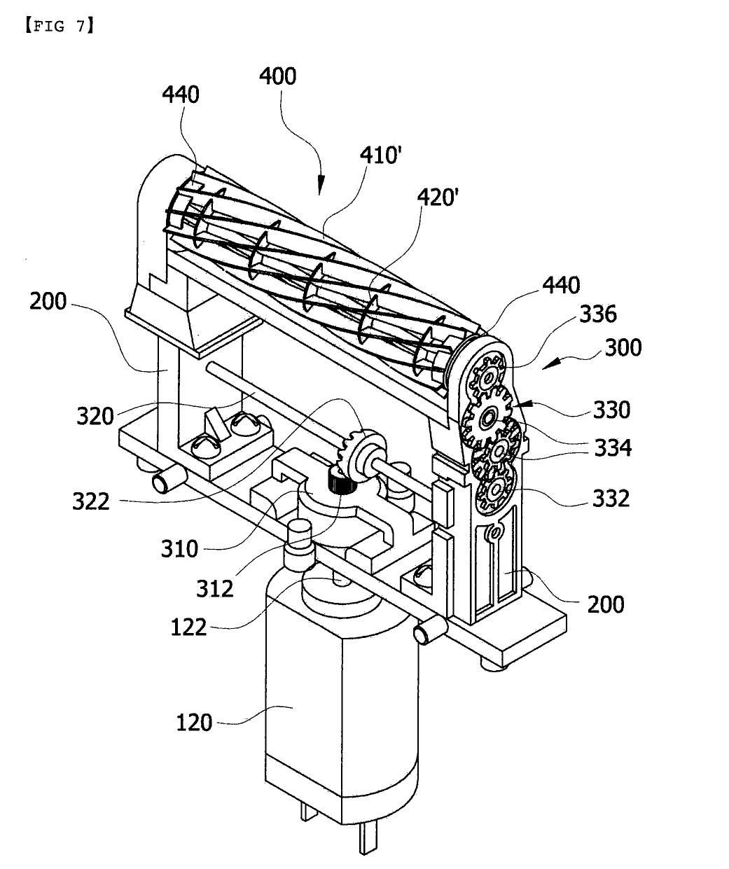

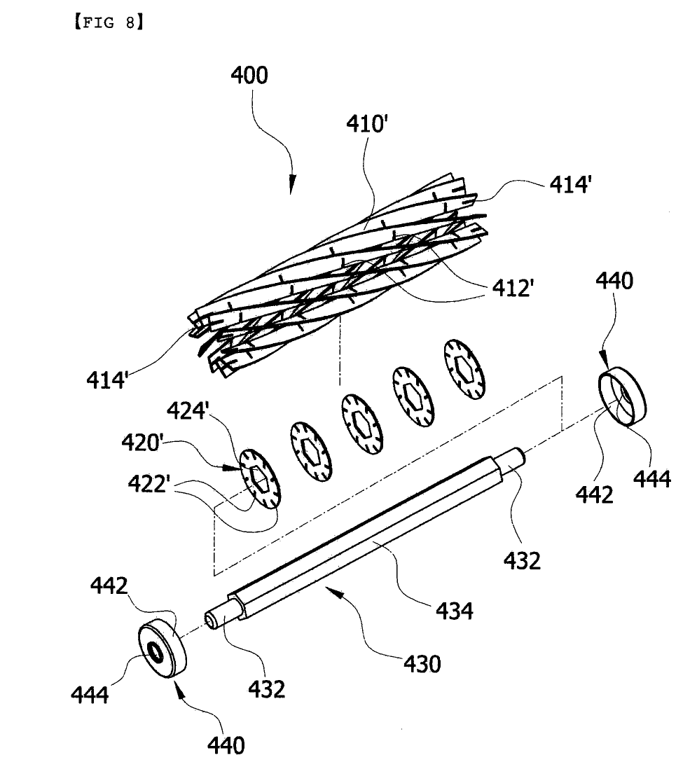

The cutting blade assembly 400 includes a cutting blade 410, 410′, a support piece 420, 420′, a driving shaft 430 and fixing piece 440, as shown in FIGS. 3 to 7 or 8.

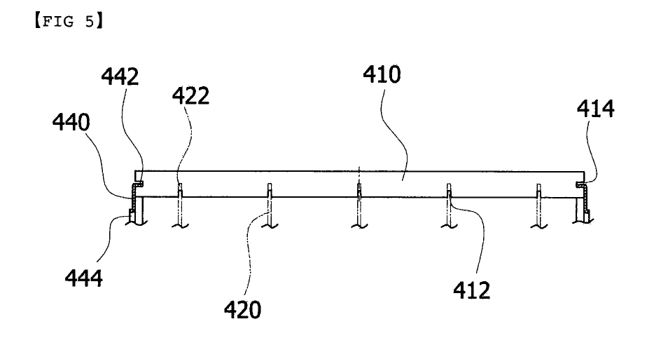

Here, the cutting blade 410, 410′, as shown in FIG. 3 or 5, is formed as a plate form extending longitudinally, and a plural first connection groove 412, 412′ is formed at equal space on one side thereof. In addition, a second connection groove 414, 414′ is formed on both ends of the cutting blade 410, 410′, respectively.

Meanwhile, a plurality of the cutting blade 410, 410′ is preferably formed on a circumference.

Meanwhile, the cutting blade 410 is formed preferably as a horizontal plate such that the first connection groove 412 that is formed on one side thereof corresponds to in a same line downwardly and is connected to the cutting blade connection groove 422 formed on the outer circumference of the support piece 420. In addition, as shown FIGS. 6 to 10, the cutting blade 410′ may be formed preferably as a spiral plate form curved at a predetermined angle such that a plurality of the first connection grooves 412′ formed on one side thereof are connected to the cutting blade connection grooves 422′ formed on the outer circumference of the support piece 420′ corresponding to the first connection groove 412′ in a same line downwardly to be discrepant to the next cutting blade groove 422′.

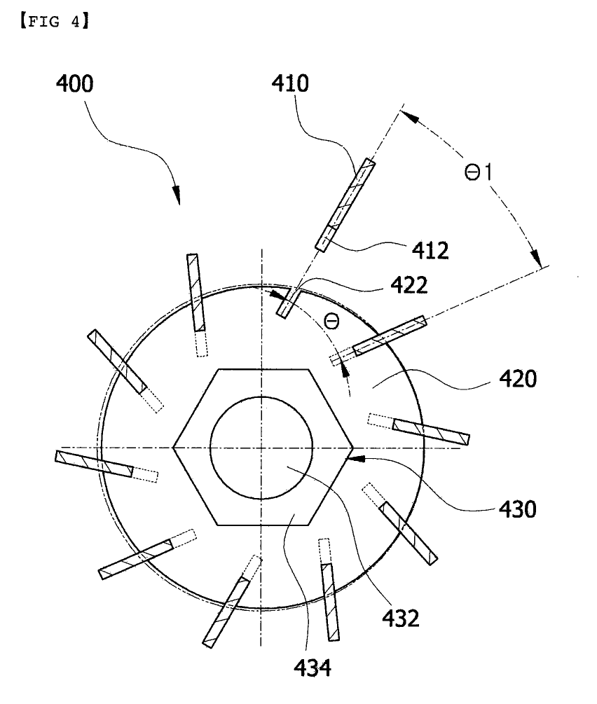

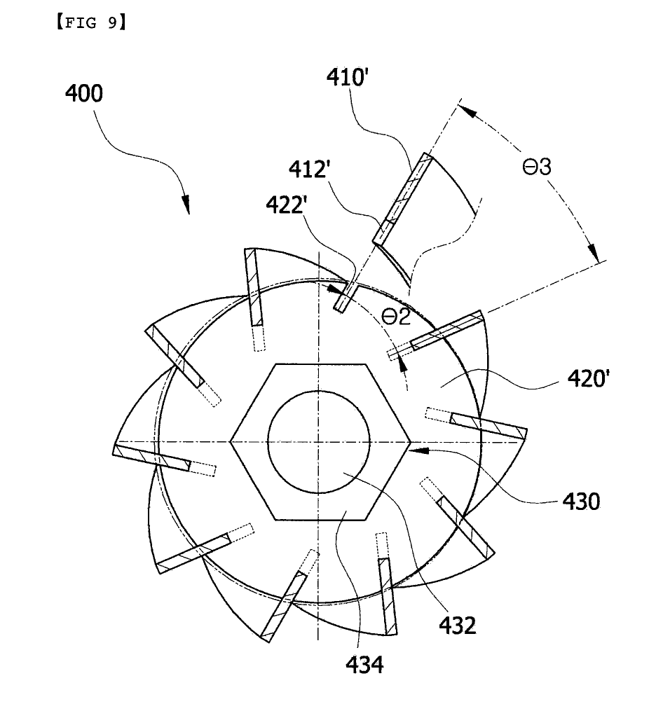

The support piece 420, 420′ is formed as a circular plate, as shown in FIG. 4 or 9, and a hexagonal hole 424, 424′ is formed on a center thereof, and the cutting blade groove 422, 422′ is formed at a predetermined angle (θ,θ2) such that the aforementioned cutting blade 410, 410′ is connected thereto to have a cutting angle (θ1, θ3). Here, a plurality of the cutting blade connection grooves 422, 422′ is formed along an outer circumference of the support piece 420, 420′ formed as a circular plate, and the number thereof corresponds to the number of the cutting blades 420, 420′. In addition, the number of the support pieces 420, 420′ corresponds to the number of the first connection grooves 412, 412′ of the cutting blade 410, 410′ to be connected to the cutting blade groove 422, 422′.

Meanwhile, circular shaft part 432 one side of which is connected to the driving support 200 and the other side of which is connected to the power transmission means 300, is formed on both end of the driving shaft 430, and a hexagonal shaft part 434, which is fitted into the hexagonal hole 424, 424′ formed on a center of the support piece 420, 420′, is formed between the circular shaft part 432 on the both ends of the driving shaft.

The fixing piece 440 is formed as a circular form and a connection rib 442 to which the second connection groove 414, 414′ formed on both ends of the cutting blade 410, 410′ is connected, is formed thereon. Additionally, a through hole 444, through which the circular shaft part 432 formed on both ends of the driving shaft 430 is connected, is formed on a center of the fixing piece 440. Here, the fixing piece 440 prevents the cutting blade 410, 410′ from being departed from the cutting blade connection groove 422, 422′ due to a centrifugal force caused from a high speed rotation.

Meanwhile, a hook piece 512 to be hooked to a cover connection hole 130 of the razor body 100 is formed on the left and right side of the cover 500 and a safety net 510 formed in a space accommodating a rotation diameter of the cutting blade 410, 410′ at a high rotation speed, is formed on the upper side of the cover. Here, the safety net 510 prevents a human body from being hurt when the cutting blade at a high rotation speed cuts hair, etc.

Hereinafter, an operation and advantageous effects from the configuration as described above will be described in detail through embodiments.

### Embodiment 1

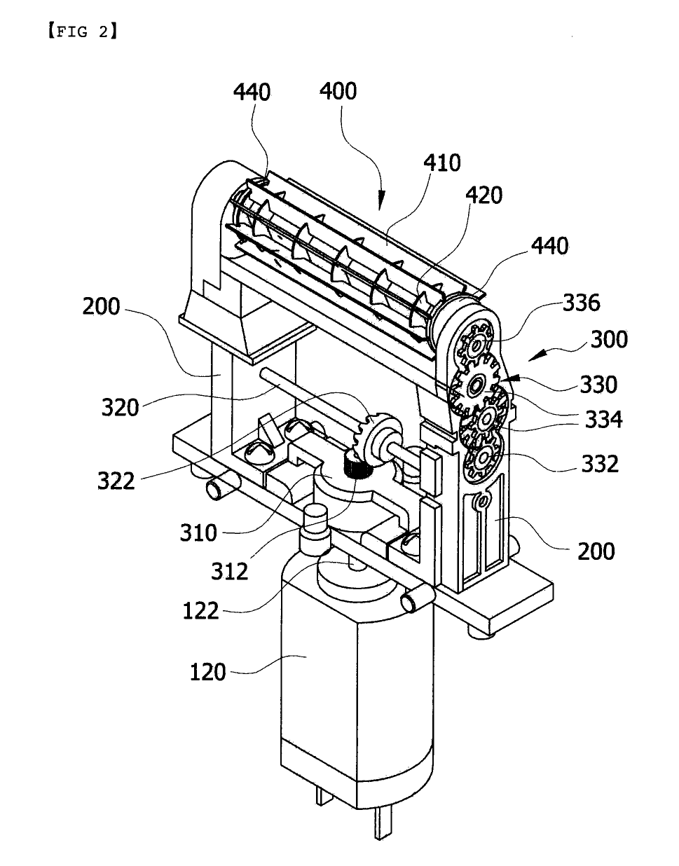

In the cutting blade assembly 400 in a form of a horizontal plate, as shown in FIGS. 1 to 3, the on/off switch 110 formed on the front surface of the razor body 100 is operated to apply power source to the driving motor 120 of the power transmission means 300 to rotate the motor shaft 122 of the driving motor 120. Here, the spur gear 312 connected to the motor shaft 122 is rotated at the same time.

In subsequent, the crown gear 322 of the power transmission rotation shaft 320 that is connected rotatably between the driving support 200 formed uprightly faced each other on the upper surface of the razor body 100, is connected to the upper spur gear 312 of the driving motor connection part 310, which is rotated horizontally, to convert into vertical rotation, and thus it rotates the power transmission rotation shaft 320. Here, at least one end of the power transmission rotation shaft 320 among both ends thereof is connected to the lower spur gear 332 of the power transmission gear part 330 to transmit a rotation force, as described above.

Subsequently, one lower spur gear 332 of the power transmission gear part 330 to which a rotation force is transmitted by the power transmission rotation shaft 320 is rotated vertically as same as the power transmission rotation shaft 320, and the middle spur gear 334 geared to the respective power transmission gear part 330 transmits a rotation force to the uppermost spur gear 336 connected to one side end of the cutting blade 410.

In subsequent, the driving shaft 430 of a cutting blade assembly 400 connected to the uppermost spur gear 336 of the power transmission gear part 330 is rotated. Here, both ends of the driving shaft 430 are formed as a circular shaft part 432, respectively, and the middle between the both ends is formed as a hexagonal shaft part 434 in a hexagonal shape. Accordingly, the driving shaft 434 is rotated at a high speed by the rotation force transmitted from the driving motor 120.

Meanwhile, a plurality of support pieces 420 on a center of which the hexagonal hole 424 is formed, and is connected to the hexagonal shaft part 434 of the driving shaft 430 being rotated at a high speed by the rotation force transmitted from the driving motor 120. Here, as shown in FIG. 4, a plurality of cutting blade connection grooves 422 having a predetermined angle (θ) is formed on the outer circumferential surface of the support piece 420 and a plurality of cutting blades 410 in a form of horizontal plate is connected thereto, and thus hair is cut continuously by a plurality of cutting blades 410 to improve cutting ability at high rotation speed. Further, as shown in FIG. 5, a plurality of first connection grooves 412 is formed at equal space on the horizontal plate type cutting blade 410 and the second connection groove 414 is formed on both ends thereof. That is, the first connection groove 412 of the horizontal plate type cutting blade 410 and a plurality of the cutting blade connection grooves 422 formed on the outer circumference of the support piece 420 at a predetermined angle (θ) are connected correspondingly in a same line to form a cutting angle (θ1) such that the improved cutting ability can be obtained when the cutting blade assembly 400 at a high rotation speed cuts hair.

Additionally, the second connection groove 414 formed on both ends of the horizontal plate type cutting blade 410 is connected to the connection rib 442 of the fixing piece 440. That is, the horizontal plate type cutting blade 410 is fitted into the support piece 420 connected to the driving shaft 430 to have a cutting angle (θ1) such that it can prevent the horizontal plate type cutting blade 410 from being departed from the support piece 420 by a centrifugal force caused from a high speed rotation.

### Embodiment 2

In the spiral plate type cutting blade assembly 400, as shown in FIGS. 6 to 8, the on/off switch 110 formed on the front surface of the razor body 100 is operated to be ON for rotating the spiral plate type cutting blade assembly 400 at a high speed to cut hair, wherein the procedures in which the rotation force from the driving motor 120 is transmitted to the spiral plate type cutting blade assembly 400 to be rotated at a high speed, is to be understood through the embodiment 1, and thus detailed description thereof is omitted.

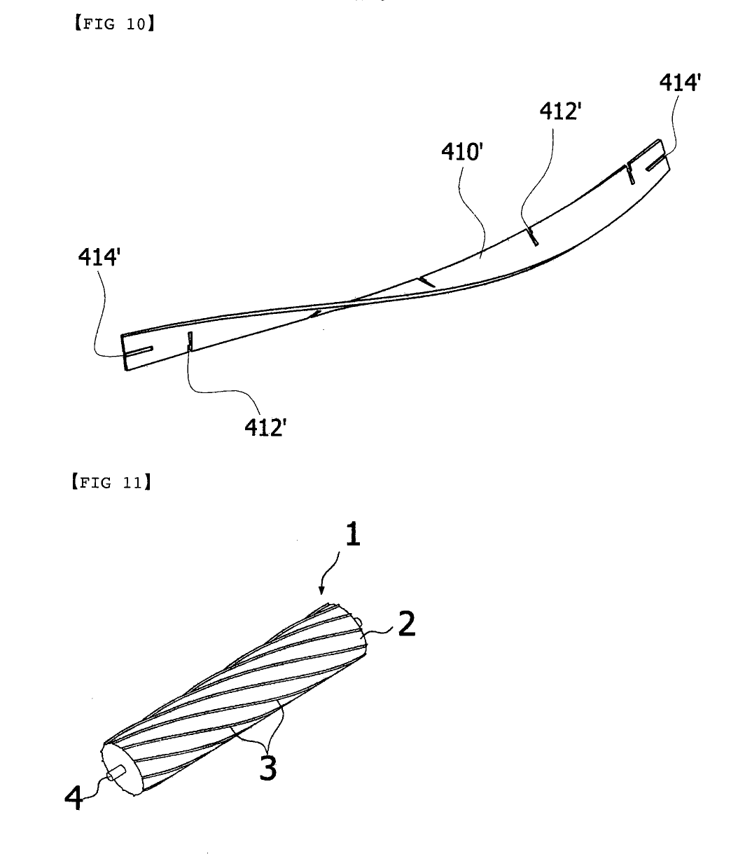

Accordingly, for the spiral plate type cutting blade assembly 400, as shown in FIG. 9, a plurality of cutting blade grooves 422′ having a predetermined angle (θ2) is formed on the outer circumference of the support piece 420′, and a plurality of the spiral plate type cutting blade 410′ is connected thereto, and thereby cutting hair continuously by the plurality of the spiral plate type cutting blades 410′ to improve a cutting ability at a high rotation speed is achieved. Further, as shown in FIG. 10, a plurality of the first connection grooves 412′ is connected to a spiral arc of the spiral plate type cutting blade 410′ at an equal distance, and the second connection groove 414′ is formed on the both ends thereof. That is, a plurality of the cutting blade connection grooves 422′ formed on the outer circumference of the support piece 420′ at a predetermined angle (θ2), corresponding to in a same line downwardly the first connection groove 412′ of the spiral plate type cutting blade 410′ is connected to in order next cutting blade connection groove 412′ on one side of the support piece 420′ along the trace of a spiral arc to form a cutting angle (θ3), and thereby improving the cutting ability when hair is cut by the spiral plate type cutting blade assembly 400.

In addition, the second connection groove 414′ formed on both ends of the spiral plate type cutting blade 410′ is connected to the connection rib 442 of the fixing piece 440 as the same way as the embodiment 1, and the cutting blade 410′ is fitted into the support piece 420′ connected to the driving shaft 430 to have a cutting angle (θ3), and thereby preventing the cutting blade of the spiral plate type being departed from the support piece 420′ due to a centrifugal force caused from a high speed rotation.

Accordingly, as described through the embodiments 1 and 2, a fabricating of a cutting blade assembly of a rotation drum type electric razor is performed easily through a plurality of connection groove, and it is evident that a disassembly thereof is performed easily. In addition, a cutting angle is formed easily by only fabricating of cutting blades and support pieces to improve a cutting ability and further for hair not to be held between the cutting blades by forming the most optimum cutting angle.

The description of the invention set forth herein is illustrative, and is not intended to limit the scope of the invention as set forth in the following claims. For example, while specific speed sensing circuits have been described, the individual components may vary. Other variations and modifications of the embodiments disclosed herein, may be made based on the description set forth herein, without departing from the scope and spirit of the invention as set forth in the following claims.

According to the cutting blade assembly of drum rotation type electric razor, a cutting angle is granted with a cutting blade of a drum type blade assembly and thus it can improve a cutting effect and solve a problem in that hairs are held between the cutting blades after shaving.

Additionally, an assembly and disassembly are performed easily and a connection thereof is secure to improve durability.

1. A cutting blade assembly of a rotation drum type electric razor including:
a razor body on which an on/off switch is formed and in which a driving motor operated by the on/off switch is embedded;
driving supports which are formed uprightly on the left and right side of upper surface of the razor body faced each other and on the upper end of which a plurality of connection holes are formed;
a power transmission means that is provided between the driving supports and is connected to the driving motor to transmit a driving force;
a cutting blade assembly which is shaft-connected to the connection hole of the driving support, to which a driving force is transmitted from the power transmission means to rotate at a high speed, and which is provided with cutting blades; and
a cover which is hook-connected to the upper surface of the razor body and on which a net covering the cutting blade assembly is formed.

2. A cutting blade assembly of a rotation drum type electric razor according to claim 1, wherein the cutting blade assembly includes:
a plurality of cutting blades which are plate-shaped extending in a longitudinal direction, on an inner diameter side of which a plurality of first connection grooves are formed, and on both ends of which second connection grooves are formed;
a plurality of support pieces in a form of a circular plate on which a plurality of cutting blade connection grooves to be connected to the plurality of first connection grooves of the cutting blades are formed along the outer circumference, and on a center of which a hexagonal hole is formed;
a driving shaft on both ends of which a circular shaft part to one side of which the driving support is connected and to the other side of which the power transmission means is connected, is formed, and which includes a hexagonal shaft part which is fitted into the hexagonal hole provided at the center of the support pieces between the respective circular shaft part; and
a fixing piece on which a connection rib to be connected to the second connection grooves of the cutting blades is formed, and on which a through hole through which the circular shaft part of the driving shaft is combined is formed.

3. A cutting blade assembly of a rotation drum type electric razor according to claim 1, wherein the cutting blade is connected to the cutting blade connection groove to form a cutting angle θ1, which is formed to have a predetermined inclination angle θ with respect to the support piece, wherein the cutting blade is formed as a horizontal plate type which is connected to the cutting blade connection grooves corresponding to the same line downright the first connection grooves of the cutting blade.

4. A cutting blade assembly of a rotation drum type electric razor according to claim 1, wherein the cutting blade is connected to the cutting blade connection groove to form a cutting angle θ3, which is formed to have a predetermined inclination angle θ2 with respect to the support piece, wherein the cutting blade is formed as a spiral plate type that is connected to in order the cutting blade connection groove of the support piece next to one cutting blade connection groove of the support piece, corresponding to the same line downright the first connection groove of the cutting blade, along the trace of spiral arc.
